(19) United States
(12) Patent Application Publication
(10) Pub. No.: US 2010/0110367 A1
(43) Pub. Date: May 6, 2010

(54) SCREWLESS MOUNTING FOR EYEGLASSES

(76) Inventor: Isaac Karpel, Weston, FL (US)

Correspondence Address: PATENTS ON DEMAND, P.A.-General, 4581 WESTON ROAD, SUITE 345, WESTON, FL, 33331, US

(21) Appl. No.: 12/529,187

(22) PCT Filed: Mar. 3, 2008
(86) PCT No.: PCT/US08/55684

§ 371 Date: Aug. 30, 2009

Related U.S. Application Data
(60) Provisional application No. 60/892,396, filed on Mar. 1, 2007.

(51) Int. Cl. G02C 5/00

(52) U.S. Cl. 351/140

(57) ABSTRACT

The combination of an eyeglass frame that has at least one temple having a hole for attachment of a lens, a lens having an opening and a mounting mechanism including an elongated rod having ribs distributed along its longitudinal axis and having a head on one end larger than the hole with its other end having a cross section enabling passing through said hole. The rod passes through the hole in the temple and the opening in the lens and projects therefrom. A locking bushing having a throughbore in which there is located at least one projecting prong for interacting with the ribs, is received on the end of the projected rod and pulled tight against the lens to securely hold the temple and lens together.

### CROSS-REFERENCE TO RELATED APPLICATIONS

This is the U.S. National Stage of PCT/US2008/055684 filed 3 Mar. 2008, which claims priority from U.S. Provisional Patent Application No. 60/892,396 filed 1 Mar. 2007, which is hereby incorporated by reference.

### BACKGROUND OF THE INVENTION

1. Field of the Invention

The invention relates to a screwless mount system for eyeglasses for mounting lenses to frames. The invention has particular applicability to rimless eyeglass frames.

2. Prior Art

Known systems for mounting frames to eyeglasses, such as the Silhouette system, are complicated, unwieldy, time-consuming and costly to the consumer.

### SUMMARY OF THE INVENTION

The object of the present invention is to provide an effective, inexpensive and quick eyeglass mount for mounting the temples or ear-pieces or end pieces of the frame to the part of the front part of the frame that holds the lenses.

Other and further objects of the present invention will become more readily apparent from the following detailed description when taken in conjunction with the appended drawings.

### BRIEF DESCRIPTION OF THE DRAWINGS

FIG. 1 is diagrammatic illustration of the novel mounting system of the present invention.

FIG. 2 is a sectional view through a novel post as used in the present invention.

FIG. 3 is a top view of the post shown in FIG. 2.

FIG. 4 is a sectional view of a novel lock bushing that coacts with the post.

FIG. 5 is a top view of the bushing shown in FIG. 4.

FIG. 6 is sectional view of a novel double post.

FIG. 7 is a top view of the double post shown in FIG. 6.

FIG. 8 is a sectional view of another novel post.

FIG. 9 is a top view of FIG. 8.

FIG. 10 is a sectional view through another novel lock bushing.

FIG. 11 is a top view of a novel modification of the post.

FIGS. 12 and 13 are views of a novel metal lock bushing.

FIGS. 14 and 15 are views of another novel metal lock bushing.

FIG. 16 is a sectional view through another post.

FIGS. 17-19 are views of another post construction.

FIGS. 20-22 are views of still another post construction.

FIGS. 23 and 24 are views of a novel post, lock bushing and washer assembly.

FIG. 25 is a sectional view of another post.

FIG. 26 is a top view of the post of FIG. 25.

FIG. 27 is a sectional view through a lock bushing.

FIG. 28 and FIG. 29 are views showing slits in eyeglass lens.

FIG. 30 is a top view of another lock bushing.

FIG. 31 is a side view of the lock bushing of FIG. 30.

FIG. 32 is a sectional view through still another post.

FIG. 33 is a diagrammatic view of the post of FIG. 32 mounted on a temple or end-piece having tow projections.

FIG. 34 is a perspective view of a washer.

FIG. 35 is a sectional view of the washer shown in FIG. 33.

FIG. 36 is a perspective view of another lock bushing.

FIG. 37 is a sectional view of the bushing of FIG. 35.

### DETAILED DESCRIPTION

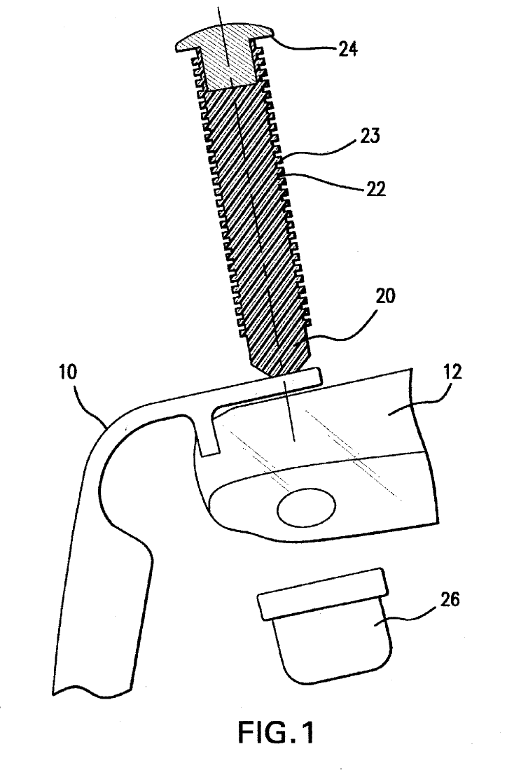

The invention provides a simple way to connect the temples or end pieces of a frame to either the front part or portion of the frame or to the lens directly. This is illustrated in FIG. 1. As seen, the temple 10 and lens 12 are each provided with an opening through which a post 20 can pass. Post 20 is plastic and cut with grooves 22 to form ribs 23. The top end of the post is recessed and threaded and receives a capped metal screw 24. When the post 20 is projected through the opening a lock bushing 26 of special design is pushed onto the projected post and locks it into position.

This new screwless mounting system has all the benefits of a screw without the drawbacks. It provides the tightest and strongest fit of any system without having to apply excessive pressure on lens. A traditional screw and nut assembly can be tightened strongly but it applies pressure to the lens which can lead to cracks in the lens. Adjustments to pressure cannot be made with a standard compression mount system. The new inventive system can be made much longer than needed so that it can be used on any thickness lens. When installation is completed, the excess is cut off. It is easier and much faster to assemble lenses on a frame.

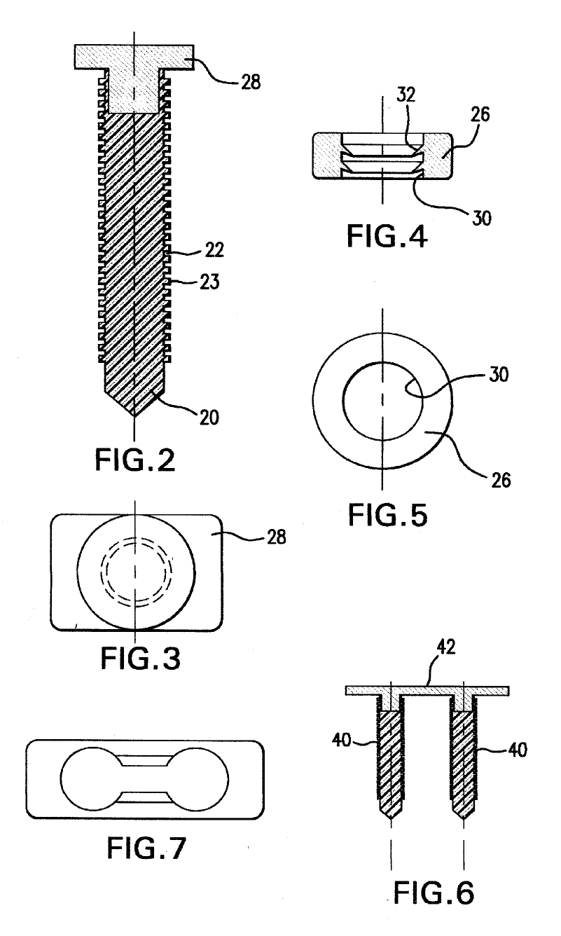

FIGS. 2 to 5 show a novel post 20 with grooves 22 and a top cap 28 inserted into a recess in the top of the post 20. The lock bushing 26 is shown in section in FIG. 4 and is composed of plastic and has inclined barbs 32 within its throughbore 30 to interact with the grooves and ribs of the post. The bushing can be pushed onto the post 20, as the barbs 32 will slide by the ribs. However, the barbs will catch in the grooves 22 and lock the bushing against reverse movement. The top part of locking bushing 26 is provided with enough softness to allow compression that provides correct pressure on lens. Locking bushing 26 is best made out of silicone. The prongs or barbs 32 are made out of a stiff plastic embedded in the silicone of the bushing 26. Another possibility for controlling pressure is to make the rods 20 out of a rubbery type material, so when pulled through the cap or locking bushing, the more it is pulled the stronger the pressure exerted on the cap and lens.

FIGS. 6 and 7 illustrate a construction that has two posts 40 with a common top 42. This enables a slit to be formed in the lens or temple to prevent rotation.

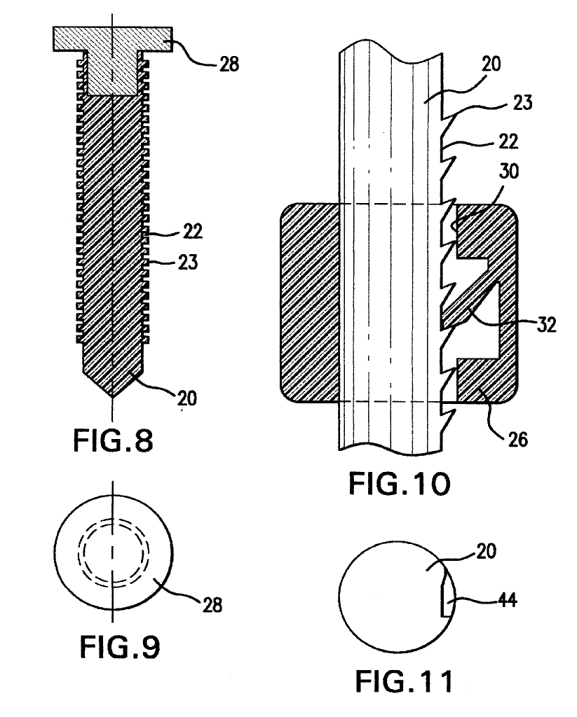

FIGS. 8 to 11 show another version. Post or rod 20 is the same configuration as described. The cap or bushing 26 has only one prong or barb 32 to interact with the slightly upwardly inclined ribs 23. The ribs are only present in one peripheral area as shown in FIG. 11 at 44.

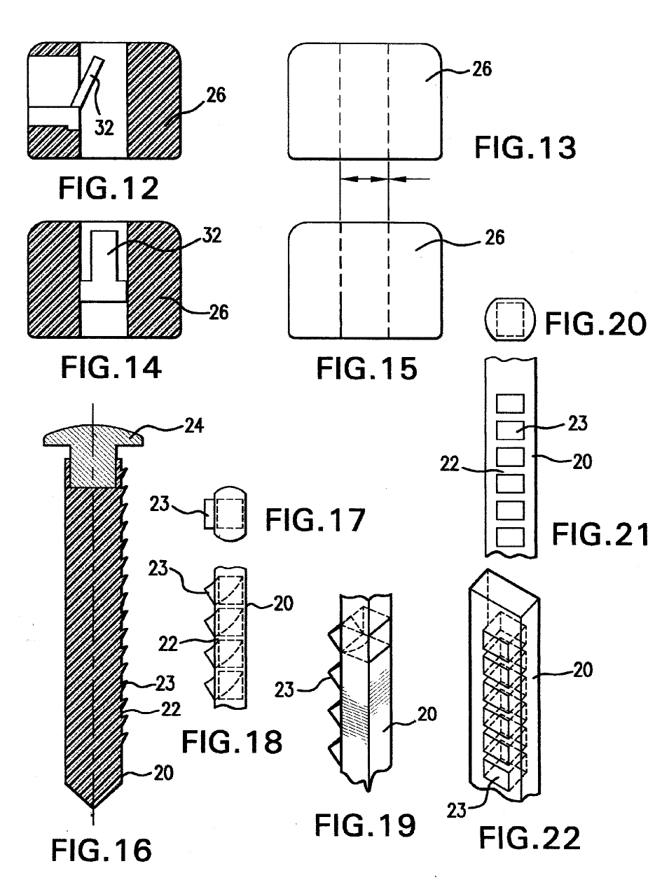

FIGS. 12 to 15 show various caps or bushings 26 utilizing either metal or plastic or a combination of both. The post with which they interact is shown in

FIG. 16 and includes a metal top that threads into a recess in the top of the post of rod.

FIGS. 17 to 22 show two versions of metal rods or posts 20 which can be stamped out.

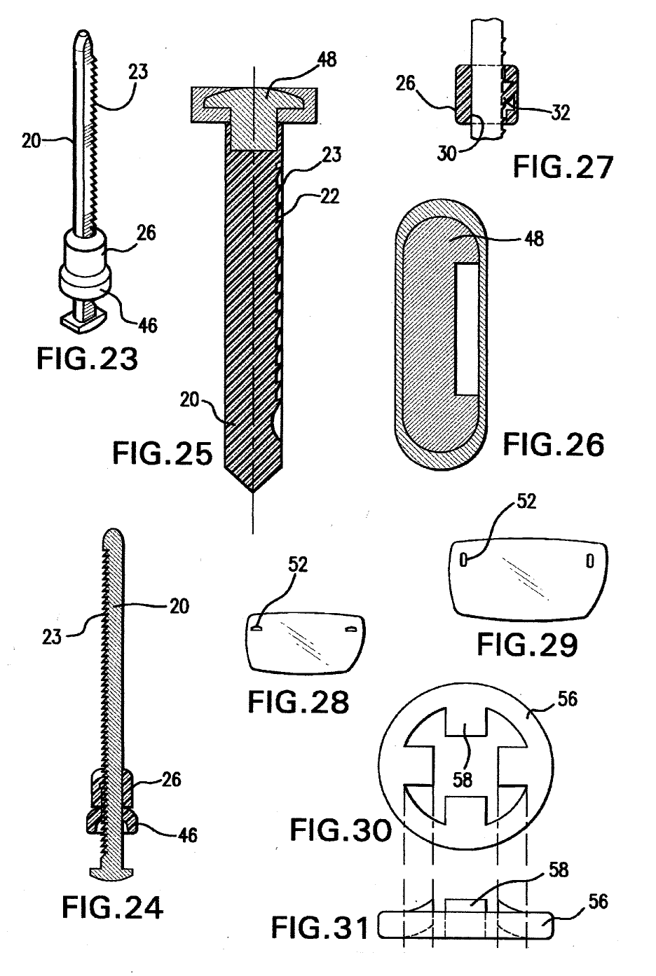

FIGS. 23 and 24 show an assembly of a post 20 with a lock bushing 26 and a washer 46 mounted on the post 20. The washer is made of a silicone to protect the lens.

FIGS. 25 to 29 illustrate the use of a post 20 rectangular in cross section. A metal cap 48 is press fitted into a recess in the top of the rod or post 20.

Using a rectangular cross section enable the lens to have an elongated slit 52 in place of a round hole. This prevents rotation of the temple when received in the lens for rimless glass frames.

FIGS. 30 and 31 show a metal lock bushing or cap 26 consisting of an annular body 56 having inwardly projecting tabs or prongs 58 bent upwardly in a cruciform pattern.

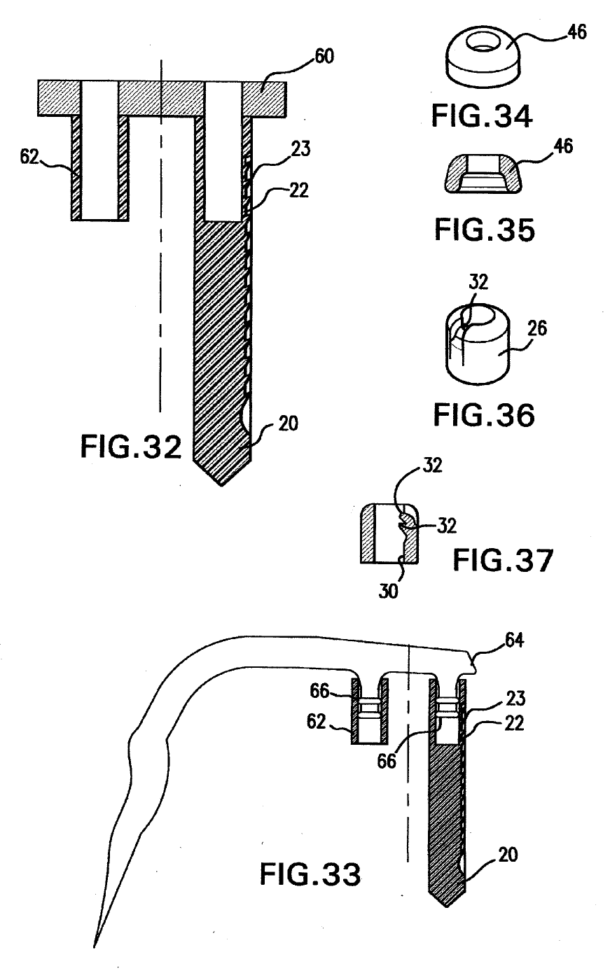

FIGS. 32 and 33 show an arrangement consisting of a top recessed post or rod 20, a top connecting bar 60 and a parallel depending tube 62 spaced from rod 20. The ribs 23 appear only on one side. This arrangement has use with a temple 64 having a pair of spaced ribbed projections 66. The post is fitted to one projection and the tube 62 to the other. The design using a post 20 and tube 62 enables the tube 62 to cover one projection to prevent rotation, and the rod 20 to cover the other barb for locking. A retaining ring may be crimped around projections and the plastic tube and post to ensure stronger hold.

Shown in FIGS. 34 to 37 are a locking bushing or cap 26 having essentially two barbs or prongs 32, and a washer 46 of silicone. The prongs 32 only appear over a short peripheral distance. Because the ribs 23 are only on one side, the prongs 32 can be rotated to remove. This configuration is meant to be used on frames designed for the SILHOUETTE mounting system and the like, using the prongs of the system and adapting the existing mounting system to work with them.

As evident from the above, the use of either two posts 20 or a post 20 and a tube 62 prevents rotation. The locking bushing is preferably made of plastic, but can be metal. The locking prongs 32 should be flexible, and only one prong may be necessary. The tops of the posts 20 can be made to match current basic screw head designs such star shape, hex, T screw, round, etc. Also, current manufacturers can change to this inventive system without having to change their current styling or molds.

The present inventive system can be all metal or all plastic or a combination of the two. Any shape screw head from most popular screws currently used in the industry or any new design required by any eyewear manufacturer can be used. It can replace the current screws being used without the need to redesign the frame.

Screw head types can be metal embedded in plastic or made all metal.

Ribbed part can be rigid or preferably soft bendable as steel wire (with ribs).

This way mounting lenses would have a lot more leeway and be easier to mount.

Use of locking mechanism with ribs and lock on one side only with alternate shape for ribs and locking pin is an advance of the present invention. Use of interchangeable head gives great advantage.

By using the curved edge on the rod acting as a cam, and the curved edge on the locking mechanism (bushing), the locking mechanism can be twisted on and off.

Although the present invention has been described in terms of specific embodiments, changes will be evident to those skilled in the art. Such changes are deemed to come within the purview of the claims.

1. A mounting mechanism for an eyeglass frame comprising an elongated rod having ribs distributed along its longitudinal axis and a locking bushing having a throughbore in which there is located at least one projecting prong for interacting with the ribs.

2. A mounting mechanism according to claim 1 wherein the mechanism includes a washer.

3. A mounting mechanism according to claim 1 wherein the top of the post is recessed.

4. A mounting mechanism according to claim 3 wherein a metal decoration is received in the recess.

5. A mounting mechanism according to claim 1 wherein a pair of elongated rods are joined at the top by a bar.

6. A mounting mechanism according to claim 5 wherein one of the rods is free of ribs.

7. A mounting mechanism according to claim 6 wherein said one of the rods is a tube.

8. A mounting mechanism according to claim 1 wherein the rod is plastic and has resiliency.

9. A mounting mechanism according to claim 1 wherein a locking bushing is made of silicone.

10. A mounting mechanism according to claim 1 wherein the rod has a non-circular cross section.

11. The combination of an eyeglass frame comprised of at least one temple having a hole for attachment of a lens, a lens having an opening and a mounting mechanism comprising an elongated rod having ribs distributed along its longitudinal axis and having a head on one end larger than the hole with its other end having a cross section enabling passing through said hole, said rod passing through the hole in the temple and the opening in the lens and projecting therefrom and a locking bushing having a throughbore in which there is located at least one projecting prong for interacting with the ribs, received on the end of the projected rod and pulled tight against the lens to securely hold the temple and lens together.

12. The combination according to claim 11 wherein the rod has a non-circular cross section.

13. The combination according to claim 11 wherein the ribs extend for less that the perimeter around the rod.

14. The combination according to claim 11 wherein a washer is interposed between the locking bushing and the lens.

15. The combination according to claim 11 wherein the prong and ribs are so designed as to be disengaged by relative rotation.

16. The combination according to claim 11 wherein two parallel rods extend from a common head and a bushing is received on each rod, and said temple has two holes and said lens has two openings.
